(19) United States
(12) Patent Application Publication
(10) Pub. No.: US 2025/0158117 A1
(43) Pub. Date: May 15, 2025

(54) Crack-Free Polymer Electrolyte Membranes for Long Cycle Life Lithium Batteries

(71) Applicant: The University of Hong Kong, Hong Kong (CN)

(72) Inventors: Dongmyeong SHIN, Hong Kong (CN); Jingyi GAO, Hong Kong (CN); Jiaming ZHOU, Hong Kong (CN); Xiaoting MA, Hong Kong (CN); Eunjong KIM, Hong Kong (CN)

(73) Assignee: The University of Hong Kong, Hong Kong (CN)

(21) Appl. No.: 18/934,782

(22) Filed: Nov. 1, 2024

Related U.S. Application Data
(60) Provisional application No. 63/598,788, filed on Nov. 14, 2023.

(51) Int. Cl. H01M 10/0565; H01M 4/58

(52) U.S. Cl. CPC H01M 10/0565; H01M 4/5825; H01M 2300/0082

(57) ABSTRACT

A method of fabricating a crack-free anionic network polymer (ANP) electrolyte membrane by conjugating anionic nodes (Monomer-Cl) with a short alkene possessing a C═C (carbon double bond) terminal group to form a structure with alkene moieties, mixing the modified anionic nodes with an ionic conductive polymer linker in organic solvent and exposing the mixture to ultraviolet (UV) light to triggers a polymerization process via click reaction to form a crack-free anionic network polymer carbon double bond (ANP-C) membrane. Forming a lithium battery from the membrane when the anionic nodes are lithium tetrakis 4-(chloromethyl)-2.3.5.6-tetrafluorophenyl) borate and the short alkene is 5-hexenol.

### CROSS-REFERENCE TO RELATED PATENT APPLICATIONS

This application claims the benefit of priority under 35 U.S.C. Section 119 (e) of U.S. Application No. 63/598,788 filed Nov. 14, 2023, which is incorporated herein by reference in its entirety

### FIELD OF THE INVENTION

The present invention relates to lithium batteries and, more particularly, to the fabrication of crack-free anionic network polymer electrolyte membranes that give such batteries a long cycle life under harsh environmental conditions.

### BACKGROUND OF THE INVENTION

Rechargeable lithium-ion batteries have transformed energy storage devices since their commercialization in the 1990s by Sony Corp. [1-3] While these batteries have found widespread use in consumer applications operating under room temperature conditions, there is a growing demand for batteries that can function under extreme thermal environments, such as high temperatures. [4] For instance, medical devices requiring sterilization and devices used in various industries like subsurface exploration and thermal reactors, which demand batteries that operate at higher temperatures. [4, 5] However, conventional lithium-ion batteries have limited high-temperature performance due to their material properties, thus leading to safety concerns or low power output. For example, liquid electrolytes commonly used in lithium batteries are composed of organic solvents with low boiling points and high flammability, which can cause fires and explosions when exposed to high temperatures. Furthermore, the instability of liquid electrolytes when used with lithium metal anodes-which have the highest theoretical specific capacity of 3860 mAh/g—is exacerbated at elevated temperatures, posing a significant challenge to achieving higher battery capacities. [6]

Solid-state electrolytes (SSEs) have emerged as a promising solution to address the challenges associated with conventional liquid electrolyte systems due to their safety and stability, especially at high temperatures. [3] In particular, solid-state polymer electrolytes (SPEs) have garnered significant interest owing to their favorable characteristics, including small volume variation during charging/discharging, superior interface behavior and low-cost processing. [3] Commercial polymer electrolytes containing lithium salt are binary-ion conductors where both lithium cations and counter anions exhibit mobility. [7] However, anions typically move faster than lithium cations because of the strong interaction between lithium cations and Lewis basic sites in the polymeric host. [8] Consequently, the accumulation of anions at the interface between the electrode and the electrolyte causes cell polarization and limited cycle life. To overcome these challenges, a single lithium-ion conducting polymer electrolyte (SIC polymer electrolyte) was proposed in the early 1980s. [9] In SIC polymer electrolytes, anions are immobilized in the polymer matrix, and most of the ionic current is transported via lithium-ion transfer. According to Newman's simulation and the Chazlviel model, this approach results in no concentration gradients and the feasibly of fast charging/discharging with minimized dendrite growth. [10-12] However, SIC polymer electrolytes exhibit a lower ionic conductivity (<10-5 S cm 1 at ambient temperature) [8, 13] compared to liquid electrolytes (˜10-3 S cm-1), limiting their practical utility. Quasi-solid or gel polymer electrolytes (QSPEs or GPEs) incorporating organic plasticizers have been employed as a trade-off to enhance the ionic conductivities. [14, 15] Nevertheless, the prospect of their practical implementation is still constrained by their vulnerability to thermal runaway under high-temperature circumstances. [3]

Perfluorinated tetraphenylborate anions have been investigated in single-ion polymer conductors due to their low electronegativity, which allows for polarization of the negative charge onto adjacent phenyl rings. Additionally, the size difference between perfluorinated tetraphenylborate anions and Li+ ions could hinder ion pair formation and aggregation, potentially facilitating conduction. [16] Taking inspiration from parent porous aromatic frameworks (PAFs) with predominantly neutral tetraphenylmethane nodes, Van Humbeck et al. designed anionic network polymers (ANP) using anionic perfluorinated tetraphenylborate nodes and rigid aromatic linkers as SIC polymer electrolytes. [17] These ANPs demonstrated high transference numbers of 0.93, but their mechanical brittleness made them challenging to shape into a format suitable for cell integration. Some of the present inventors subsequently reported new SICs (ANP-5) that incorporate weakly coordinating borate anion nodes and flexible oligoethylene glycol linkers, achieving a noteworthy conductivity of 10⁻⁴ S cm⁻¹, along with remarkable ionic selectivity (tLi+˜1) while using 30% plasticizer. [18] The fabrication of ANP-5 membranes involves the initial step of subjecting them to sonication, which generates an organic suspension of small polymer particles. This process is time-consuming and may potentially introduce interfacial resistance between these particles, thereby impeding the overall conductivity of the membrane. Furthermore, ANP-5 membranes exhibit limited flexibility, which could further constrain their practical utility.

In order to make solvent-free SIC electrolytes, a series of ANP-BEGs were synthesized by multi-armed longer polyethylene glycol as linkers. Among these ANP-BEGs, the most favorable exhibited a high room-temperature ionic conductivity (3.02× 10⁻⁷ S cm⁻¹) and demonstrated elevated selectivity towards lithium-ion conduction (tLi+=0.979). However, incorporation of PVDF binder in the polymer suspension during ANP-BEG electrolyte membrane production caused an obvious decline in conductivity.

In the article, “Dependence of Linker Length and Composition on Ionic Conductivity and Lithium Deposition in Single-Ion Conducting Network Polymers,” https://pubs.acs.org/doi/10.1021/acs.macromol.1c00911 there is disclosed the design of several anionic polymer network electrolytes. However, the resulting products are in the form of powders and have not been transformed into flexible membranes for testing their electrochemical properties. The article “Engineered networking in a family of solvent-free single-ion conducting borate network polymer electrolytes for Li-metal battery applications,” https://www.sciencedirect.com/science/article/pii/S1385894722038906?via % 3Dihub suggests a method for incorporating PVDF as a binder with an anionic network polymer to make a membrane. Although a flexible membrane could be obtained, the result shows that there is an obvious decline in ionic conductivity after introducing PVDF. The concept of an anionic network polymer electrolyte is disclosed in the article “Tetraarylborate polymer networks as single-ion conducting solid electrolytes,” https://pubs.rsc.org/en/content/articlelanding/2015/sc/c5sc02052b. However, the experiments in the article only involve testing the polymer in powder form and do not include battery cell measurements. The article, “A Single-Ion Conducting Borate Network Polymer as a Viable Quasi-Solid Electrolyte for Lithium Metal Batteries,” https://onlinelibrary.wiley.com/doi/10.1002/adma.201905771 describes the successful creation of an anionic network polymer electrolyte membrane. However, the membrane's lack of flexibility impedes its further application in lithium batteries. U.S. Pat. No. 10,243,239 discloses a method for producing a polymer network electrolyte membrane using free-radical polymerization between carbon-carbon double bonds. Notably, the network does not contain fixed anions.

Thus, previous research has resulted in the development of several anionic network polymer electrolytes. However, most of these have failed to be converted into membranes, and the resulting membranes often exhibit numerous cracks, hindering the transfer of lithium ions and promoting dendrite growth in battery operation. Moreover, some prior methods have relied on the use of additional binders to create crack-free membrane. Unfortunately, these binders tend to decrease the membrane's ionic conductivity and negatively impact its performance during cyclability.

### SUMMARY OF THE INVENTION

The present invention is directed to a novel approach for one-step synthesis of a solvent-free single-ion perfluorinated-tetraphenylborate-anions membrane via click reaction. The one-step synthesis of the membrane exhibits a high ionic conductivity (˜3*10⁻⁵) at 88° C. due to its consistent structure. Notably, the membrane demonstrates superior non-flammability properties. Furthermore, the membrane can operate under large temperature ranges from 60 to 120° C., even under negative pressure, making it suitable for a variety of applications.

Remarkably, stable long-term cycling of LifePO₄ cathodes can be achieved at 100° C. with a coulombic efficiency of approximately 100% over 400 cycles at 0.5° C. Furthermore, a review of the present invention offers valuable insights into the transport of lithium-ions in ANP via molecular dynamic simulations, thereby benefiting future designs of anionic electrolytes.

The process of the present invention involves using a chemical reaction called thiol-ene click chemistry to directly create crack-free membranes. First, anionic nodes called lithium tetrakis 4-(chloromethyl)-2.3.5.6-tetrafluorophenyl) borate are conjugated with another chemical called 5-hexenol. This reaction forms a structure with alkene moieties. Second, the modified anionic nodes are mixed with an ionic conductive polymer linker called poly(ethylene glycol) (PEG) dithiol in organic solvent, and then exposed to ultraviolet (UV) light, which triggers a polymerization process. This results in the formation of crack-free anionic network polymer membranes.

By utilizing alkene groups to modify the anionic nodes, anionic polymer electrolyte membranes are directly produced without any cracks by employing thiol-ene click chemistry. The resulting membrane exhibits a consistent structure, leading to higher ionic conductivity. It can operate reliably over a wide temperature range, making it a promising option for diverse applications. Furthermore, the membrane enables stable and efficient cycling of Li-metal batteries, even under high temperatures. The invention's direct polymerization method results in crack-free anionic network polymer electrolyte membranes that offer improved performance, long-term cyclability, and reliable operation in Li-metal batteries. This innovation addresses the crucial issue of crack formation in anionic network polymer electrolyte membranes and offers a promising solution for improving the performance and safety of batteries, particularly in extreme thermal environments.

Overall, this invention offers a way to create crack-free anionic network electrolyte membranes for Li-metal batteries, providing enhanced long-term cyclability and reliability. The lack of cracks shows higher ionic conductivity and better cyclability in a Li metal battery. Thus, this membrane fulfils the long-felt need for a more reliable and efficient lithium-ion battery that can operate under extreme thermal conditions, making it suitable for a variety of applications, including in medical devices that require sterilization and in industries like subsurface exploration and thermal reactors.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A shows a scheme for the creation of a synthetic anionic network polymer electrolyte, FIG. 1B shows partial FITR spectra of Monomer and Monomer —C═C, FIG. 1C shows ¹HNMR and ¹³CNMR spectra of Monomer —C═C, FIG. 1D is a partial FTIR spectra of Monomer —C═C, anionic network polymer membrane and SH-PEG-SH, FIG. 1E is a fabrication procedure for an anionic network polymer membrane, FIG. 1F shows stress-strain curves of ANP-C-2.0k, and FIG. 1G shows resistance values for ANP-C-2.0k after bending several times;

FIG. 2A shows an FT-IR spectrum for characterizing 2,3,5,6-tetrafluorobenzyl chloride, FIG. 2B shows an ¹H NMR spectra in CDCl₃ and FIG. 2C shows ¹³C NMR spectra in CDCl₃;

FIG. 3A shows an FT-IR spectrum for characterizing lithium tetrakis(4-(chloromethyl)-2,3,5,6 tetrafluorophenyl) borate, FIG. 3B shows an ¹H NMR spectra in MeCN-d₃ for characterizing lithium tetrakis(4-(chloromethyl)-2,3,5,6 tetrafluorophenyl) borate and FIG. 3C shows ¹³C NMR spectra in MeCN-d₃ for characterizing lithium tetrakis(4-(chloromethyl)-2,3,5,6 tetrafluorophenyl) borate;

FIG. 4A shows an FT-IR spectrum for characterizing lithium tetrakis(4-(chloromethyl)-2,3,5,6 tetrafluorophenyl) borate with alkene (Borate node-C═C monomer), FIG. 4B shows an ¹H NMR spectra in DMSO-d₆, FIG. 4C shows ¹³C NMR spectra in DMSO-d₆ and FIG. 4D shows an 19F NMR Spectra in DMSO-d₆;

FIG. 5 is an FT-IR spectrum of ANP-C-nK;

FIG. 6 shows frequency dependency of the storage (G′) and loss (G″) moduli for ANP-C-2.0K membrane at 28° C. and 60° C.;

FIG. 7A shows temperature-dependent ionic conductivities of ANP-C-nKs, FIG. 7B shows partial FTIR spectra of ANP-C-nKs, FIG. 7C shows DSC curves of ANP-C-nKs, FIG. 7D shows XRD patterns at 25° C. of ANP-C-nKs, FIG. 7E shows XRD patterns of ANP-C-2.0k at evaluated temperature, FIG. 7F shows mean square displacement as a function of time at 70° C., FIG. 7G shows a combustions test of ANP-C-2.0k and FIG. 7H shows a combustion test of propylene carbonate;

FIG. 8 shows temperature-dependent ionic conductivity for ANP-C-1.0K and powder ANP-PEG1K;

FIG. 9 shows SEM images of an ANP-C-1K membrane and ANP-PEG1k powder;

FIG. 10 shows graphs of TGA results for ANP-C-nKs;

FIG. 11A shows XRD patterns for ANP-C-3.4K and FIG. 11B shows XRD patterns for ANP-C-5.0K;

FIG. 12 is a graph of the dependence of dielectric loss on frequency for ANP-C-nKs at 25° C.;

FIG. 13A shows the binding energies of ANP-C-2K and PEO2K/LiTFSI, FIG. 13B is a graph of the Li-B distance of ANP-C-nKs, FIG. 13C shows the Li-O distance of ANP-C-nKs, FIG. 13D shows the numbers of oxygen atoms coordinating with lithium cations at different lithium cations position when lithium cations are near borate anions, FIG. 13E shows the numbers away from borate anions and FIG. 13F shows a scheme for boron anions propelling Li-ions movement in anionic polymer network;

FIG. 14 shows the temperature-dependent ionic conductivity for ANP-C-2.0k and PEO2K/LiTFSI;

FIG. 15A shows the ion conducting selectivity for ANP-C-2.0K with current decay curves (top) and the impedance spectra (bottom) before and after polarization (filled and open symbols, respectively), FIG. 15B shows oxidation stabilities at different temperatures, FIG. 15C and FIG. 15D show potential profiles of the lithium plating/stripping in a symmetric Li|electrolyte|Li cell at different current densities and FIG. 15E shows SEM images of cross-section of electrolyte after galvanostatic polarization measurements;

FIG. 16 shows lithium transference numbers of ANP-C-nKs;

FIG. 17A show capacity performance battery tests for ANP-C-2.0K at 0.2 C with various temperatures; FIG. 17B shows battery charging profiles with different temperatures, FIG. 17C shows battery capacity performance at 0.2 C under 100° C., FIG. 17D shows battery cycle performance at 0.5 C and 100° C., FIG. 17E shows ANP-C-2.0K cell cycle numbers under high temperature compared to other electrolytes reported in the literature, FIG. 17F shows thermal abuse test results on continuous heating of a flat heater and FIG. 17G shows the results of a vacuum-heating test in a vacuum environment of 100° C.;

FIG. 18. shows capacity performance of a LFP|ANP-C-2.0k|Li cell under different C rate at 60° C.;

FIG. 19 shows capacity performance of a LFP|ANP-C-2.0k|Li cell under different C rate at 90° C.;

FIG. 20 shows capacity performance of a LFP|ANP-C-2.0k|Li cell under different C rate at 110° C.; and

FIG. 21A shows an SEM image of a cross-section of an LFP|ANP-C-2.0k|Li cell at a scale of 100 μm, FIG. 21B shows the cross section at a scale of 2 μm, FIG. 21C shows the ANP membrane at a 2 μm scale and FIG. 21D shows the membrane anode interface at 2 μm.

### DETAILED DESCRIPTION OF THE INVENTION

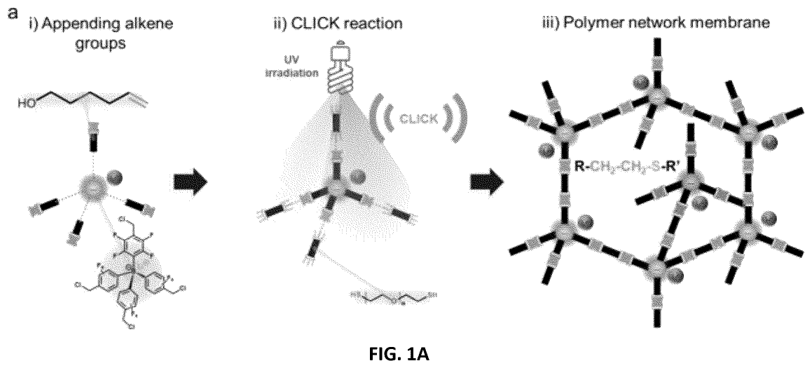

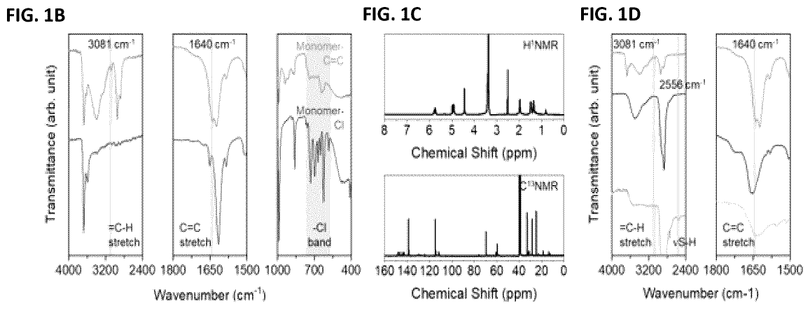

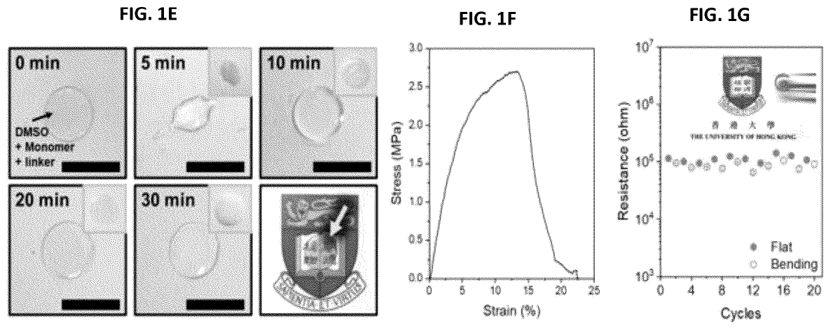

To synthesize an anionic membrane for use in the present invention, anionic nodes (Monomer-Cl) are first conjugated with a short alkene possessing a C═C terminal group through nucleophilic substitution (FIG. 1A, i). Poly(ethylene glycol) dithiol (SH-PEG-SH) is then employed as a linker to react with the anionic nodes with C═C terminal group (Monomer —C═C) under ultraviolet light via a click reaction, facilitating the formation of a polymer electrolyte membrane with a consistent structure (FIG. 1A, ii and iii).

In the FT-IR spectra (FIG. 1B), the Monomer —C═C presented the characteristic IR peaks of ═C—H and C═C stretching vibration at 3081 cm⁻¹ and 1640 cm⁻¹, respectively. Notably, the strong C—Cl bands in Monomer-Cl in the frequency range of 600-800 cm-1 could not be observed in Monomer —C═C, indicating that the benzyl chloride groups were successfully displaced by nucleophilic substitution. [20] These results show that the Monomer-Cl underwent successful modification with C═C functional groups.

The HNMR and CNMR spectra of Monomer —C═C in FIG. 1C further provide evidence of a clearly defined chemical structure. Then, Monomer —C═C and SH-PEG-SH with varying molecular weights of 1.0K, 1.5K, 2.0K, 3.4K, 5K, respectively, are incorporated in DMSO solution together with a photo-initiator to directly generate a consistent membrane under ultraviolet light. Here, the membrane obtained by using linkers of different molecular weights is abbreviated as ANP-C-nK, where nK represents the molecular weight of the linker. During the polymerization process, the terminal functional groups of Monomer —C═C react with —SH groups in SH-PEG-SH to form C—S—C bonds, resulting in the development of a polymer electrolyte network. As shown in FIG. 1D, the characteristic IR peaks of ═C—H and C═C stretch vibrations of Monomer —C═C at 3081 cm⁻¹ and 1640 cm⁻¹, respectively, as well as S—H bending vibrations of SH-PEG-SH at 2556 cm⁻¹ disappear completely after polymerization, indicating that Monomer —C═C and SH-PEG-SH were successfully connected to form anionic network via a click-reaction. [21, 22]

The details of the synthesis of an ANP-C-nK membrane are as follows: The borate node with C═C monomer and SH-PEG-SH linker with the molecular ratio of 1:2 are dissolved in DMSO. The weight percentage of the mixture solution is around 50%. DMPA (1% wt) is added into the mixture. Then, the solution is transferred into vacuum vessel to totally remove bubbles inside. After that, the mixture solution is added to the PDMS mold under UV light for 30 min. A yellow membrane is formed and soaked in methanol and THE respectively at 60° C. for 6 h three times to remove impurities. Then, the electrolyte membrane is first dried at 60° C. for removal of most of the solvent, and then further dried at 120° C. under vacuum for 18 h to fully remove trace of solvent.

Syntheses of borate monomer can be conducted under a dry Ar atmosphere via standard Schlenk techniques. Anhydrous diethyl ether, tetrahydrofuran (THF), 1,4-dioxane and SH-PEG-SH (Mn=˜ 1k) may be purchased from Sigma-Aldrich. Organic solvents are dried with molecular sieves (4A) to further remove water. 5-Hexen-1-ol purchased from TCI is then stored with molecular sieves for at least 48 h before use. SH-PEG-SH (Mn=˜ 1.5k, 2k, 3.4k, 5k) may be bought from Aladdin. All other chemicals are purchased from commercial vendors and used as received without further purification. 1H, 19F and 13C Nuclear magnetic resonance (NMR) spectra were recorded by Bruker AV 400 MHz spectrometer and 600 MHz spectrometer at room temperature, respectively. Samples were dissolved in MeCN-d3, CDCl3 or DMSO-d6. FT-IR spectra were collected using PerkinElmer Spectrum two. Thermogravimetric analysis (TGA) was carried out at a heating rate of 10K/min in a nitrogen flow (20 mL/min). Differential scanning calorimetry (DSC) was measured from 4° C. to 250° C. at a heating rate of 5° C. min-1 under nitrogen atmosphere. Shear modulus obtained by X-ray diffraction (XRD) spectra was collected. Strain stress measurements were conducted by Rheometer AERS G2 tensile tester.

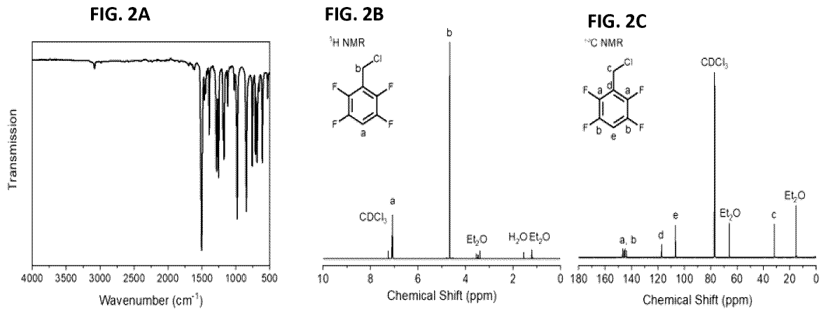

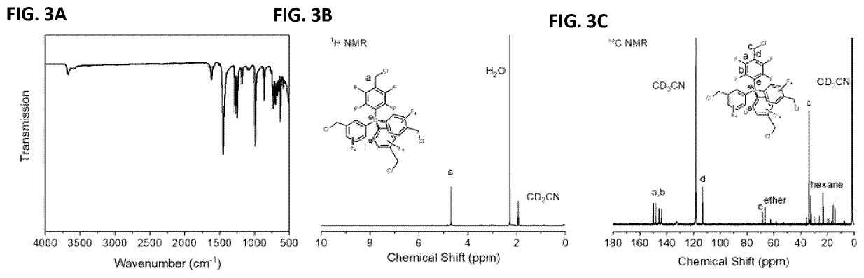

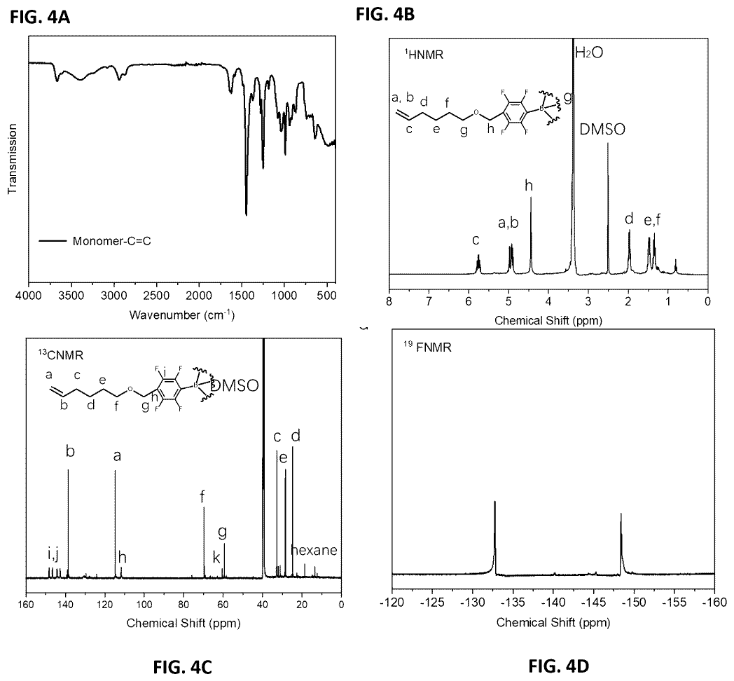

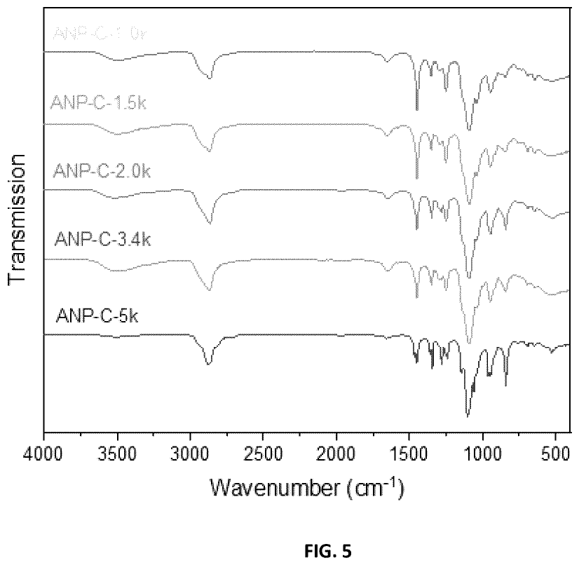

The characterization of products in each synthesizing step is shown in FIG. 2A to FIG. 5, including the proton, carbon and fluorine nuclear magnetic resonance (¹H NMR and ¹³C NMR, 19F NMR) as well as Fourier-transform infrared spectroscopy (FT-IR) spectra. In particular, FIG. 2A shows an FT-IR spectrum characterizing 2,3,5,6-tetrafluorobenzyl chloride, FIG. 2B shows a ¹H NMR spectra in CDCl3 and FIG. 2C shows ¹³C NMR spectra in CDCl3. FIG. 3A shows a FT-IR spectrum characterizing lithium tetrakis(4-(chloromethyl)-2,3,5,6 tetrafluorophenyl) borate, FIG. 3B shows an ¹H NMR spectra in MeCN-d3 characterizing lithium tetrakis(4-(chloromethyl)-2,3,5,6 tetrafluorophenyl) borate, and FIG. 3C shows ¹³C NMR spectra in MeCN-d3 characterizing lithium tetrakis(4-(chloromethyl)-2,3,5,6 tetrafluorophenyl) borate. FIG. 4A shows an FT-IR spectrum characterizing lithium tetrakis(4-(chloromethyl)-2,3,5,6 tetrafluorophenyl) borate with alkene (Borate node-C═C monomer), FIG. 4B shows an ¹H NMR spectra in DMSO-d6, FIG. 4C shows ¹³C NMR spectra in DMSO-d6 and FIG. 4D shows an ¹⁹F NMR spectra in DMSO-d6. FIG. 5 is an FT-IR spectrum of ANP-C-nK;

The synthesis of 2,3,5,6-tetrafluorobenzyl chloride

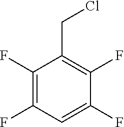 [SMILES: Fc1cc(F)c(F)c(CCl)c1F]

is as follows:

2,3,5,6-tetrafluorobenzyl alcohol (10.0 g), tetrabutylammonium chloride (7.8 g) and thionyl chloride (23.0 mL) are separately added into an oven-dried Schlenk flask. Then, the solution is mixed at 85° C. for 2 h. After being cooled down to room temperature, the flask is placed into a 0° C. ice bath. Deionized water (40 mL) is added to the flask to quench the reaction. Then, concentrated aqueous Na₂CO₃ (40 mL) is slowly added to the solution, and solid Na₂CO₃ is added thereafter to get the solution to a pH of 6. The solution is extracted with 40 mL of diethyl ether four times. The organic layer is collected and washed with 40 mL of brine, dried with MgSO₄. A yellow oil is obtained after the removal of diethyl ether by rotary evaporation under reduced pressure. Finally, a transparent oil is harvested in a flask surrounded by liquid N₂ by vacuum distillation. Yield: 8.9 g (86%).

The synthesis of lithium tetrakis(4-(chloromethyl)-2,3,5,6-tetrafluorophenyl) borate (Monomer)

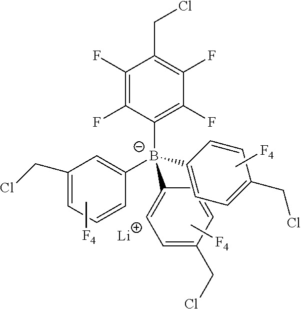

is next achieved as follows:

Tetrafluorobenzyl chloride (2.01 g, 10.1 mmol) is added into a 200 mL oven-dried Schlenk flask by syringe. The flask is charged with 100 mL of anhydrous diethyl ether via cannula and then placed into a dry ice bath (−78° C.). 4.93 mL (9.8 mmol) of 2 M n-butyllithium in hexanes is slowly added into the solution via syringe. After one hour, 1.0 M boron trichloride in heptanes (2.24 mL) is added dropwise via syringe. The solution is stirred at −78° C. for 2 h, and is then warmed up to room temperature as the dry ice evaporates. After 18 h, 30 mL of a 0.1 M aqueous LiCl is used to quench the reaction. The organic layer is collected, washed with 0.1 M LiCl aqueous solution (30 mL) twice, and then dried with MgSO₄. A pale-yellow oil is harvested by concentrating the organic solution via rotary evaporator. The oil is then transferred into a vial and dissolved in 1 mL of dichloromethane. The solution is purified by precipitation in hexane three times. White-yellow solid powder is obtained after the removal of trace solvent under vacuum. Yield: 1.3 g (65%).

Finally the synthesis of lithium tetrakis(4-(chloromethyl)-2,3,5,6-tetrafluorophenyl) borate with alkene (Borate node-C═C monomer)

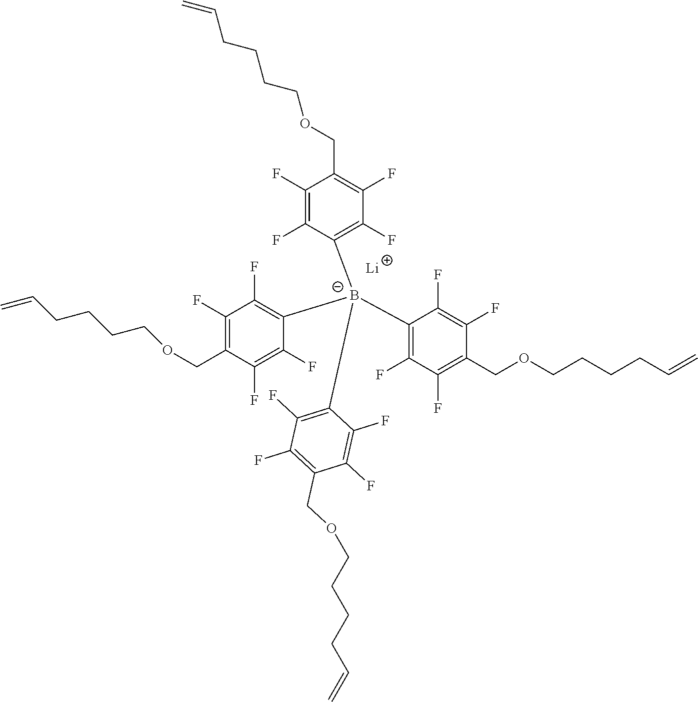 [SMILES: C=CCCCCOCc1c(F)c(F)c([B-](c2c(F)c(F)c(COCCCCC=C)c(F)c2F)(c2c(F)c(F)c(COCCCCC=C)c(F)c2F)c2c(F)c(F)c(COCCCCC=C)c(F)c2F)c(F)c1F ; [Li+]]

is as follows:

Lithium tetrakis(4-(chloromethyl)-2,3,5,6-tetrafluorophenyl) borate (100 mg) is transferred into a vial and heated at 60° C. under vacuum overnight to fully remove water before use. 5-Hexen-1-ol (240 μL) is added into a 50 mL oven-dried Schlenk flask. 1.4 mL THF is transferred to dissolve the linker via syringe. Then, 1.5 mL of 2 M n-butyllithium in hexanes is slowly added into the solution at room temperature with stirring. After 1 h, the THF is removed by vacuum and replaced by anhydrous 1,4-dioxane (2 mL). Then, borate monomers are dissolved in 2 mL of anhydrous 1,4-dioxane and transferred into the flask via syringe. The vial is rinsed with additional anhydrous 1,4-dioxane (1 mL) and the solution is then added into the flask with stirring. The flask is placed into an oil bath at 80° C. while stirring under Ar. After 48 h, the solution is then filtered, and the resulting yellow solution is transferred into a vial. After evaporating the solvent, the remaining yellow product is dissolved in 1 mL of dichloromethane. The solution is purified by precipitation in hexane three times. Yellow solid product is obtained after the removal of trace solvent under vacuum. Finally, the product is dried at 60° C. under vacuum overnight. Yield: 42 mg (42%).

Powder ANP-PEG1K electrolyte was synthesized according to the inventor's previous work. [18]

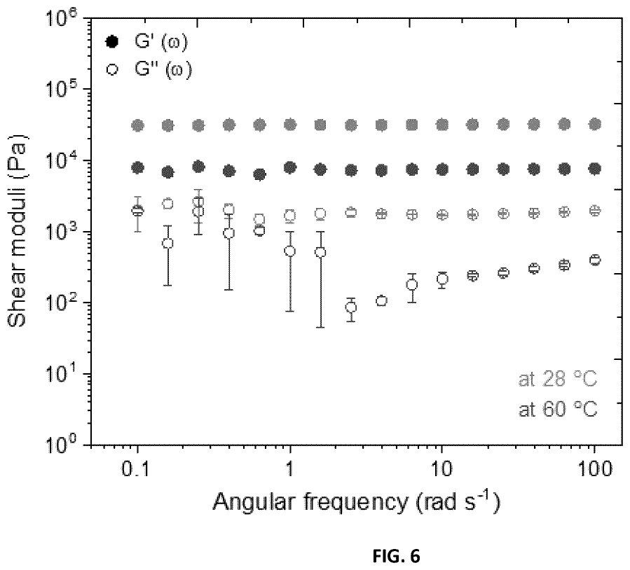

The optimal time for membrane formation was also investigated. FIG. 1E illustrates that an increased UV exposure time results in a well-formed gel structure. Following 30 minutes of UV exposure, the mixture solution can form a completely transparent and pliable gel within the mold. The organic solvent is then washed and totally evaporated, resulting in a fully dry yellow flexible membrane. The stress-strain behavior of ANP-C-2.0K membrane was quantified at room temperature using a Rheometer AERS G2 tensile tester (FIG. 1F). The Young's modulus of the ANP-C-2.0K membrane was determined to be approximately E=20.42 MPa. Storage (G′) and loss (G″) shear moduli of the membrane were also evaluated at 25° C. and 60° C. (FIG. 6). Both G′ and G″ show frequency independence, with G′ being about one order of magnitude higher than G″ across the entire frequency range, confirming that the membrane behaves as an elastic solid. [23,24] The shear modulus of the ANP-C-2.0K membrane decreased from 31.9±0.5 KPa to 7.52±0.44 KPa with increasing temperature from 25° C. to 60° C., indicating that the membrane becomes softer which may facilitate better interfacial adhesion between cathode and electrolytes. These mechanical tests suggest that the membrane electrolytes have potential advantages in maintaining adhesion during charging and discharging. As shown in FIG. 1G, the ANP-C-2.0K membrane exhibited consistent resistance irrespective of its bending or flat status after several cycles, thereby indicating its inherent flexibility and durability.

Measuring the ionic conductivity of lithium-ion polymer electrolytes commonly involves using the AC impedance method. This method entails applying a small sine wave of specific amplitude to the system and obtaining the impedance spectrum by varying the frequency. Typically, the Amiral Squidstat Plus is used to investigate the ionic conductivity within an argon-filled glove box. The sample is enclosed within stainless-steel electrodes placed in a Swagelok cell. By applying a 100-mV ac to the Swagelok cell within a frequency range of 1 MHz to 1 Hz, the ionic conductivity of the sample can be calculated using the provided equation.

$$σ = \frac{l}{R S}$$

where 1 is the sample thickness, S indicates the area of sample, and R refers to the bulk resistance.

The Swagelok cell, containing the electrolyte, is assembled and then placed in the Belektronig BTC-LAB-A20 temperature controller for temperature-dependent measurements. Impedance spectra are collected at 28° C., 38° C., 48° C., 58° C., 68° C., 78° C., and 88° C., with three measurements taken at each temperature. The variable-temperature ionic conductivities are determined using the Arrhenius and Nernst-Einstein equations:

$$σ T = {σ}_{0} exp ( \frac{- {E}_{a}}{R T} )$$

where R is gas constant. Ea and T mean the activation energy and absolute temperature, respectively.

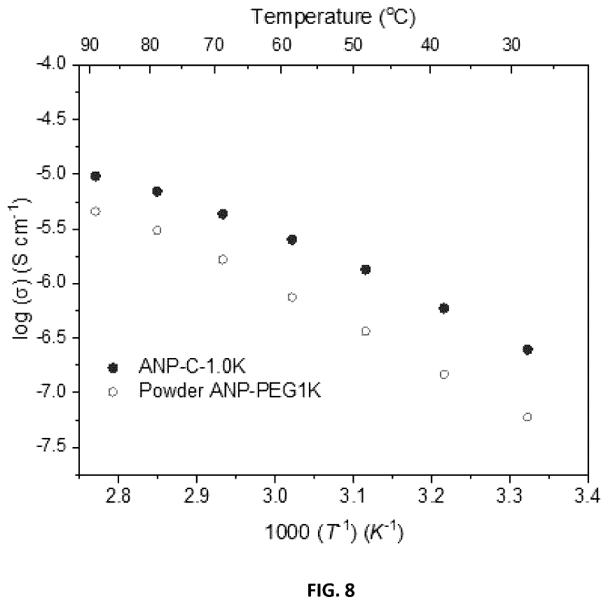

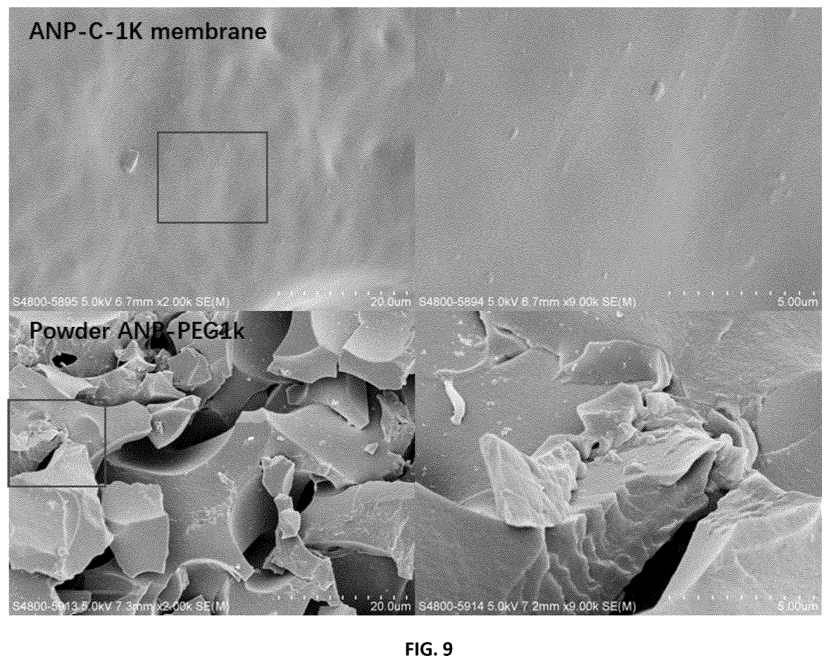

The Arrhenius plot in FIG. 2A illustrates the Li+ conduction behavior of all ANP-C-ks. The ionic conductivities of ANP-C-1.0k and ANP-C-1.5k can reach 2.48×10⁻⁷ S cm-1 and 3.86×10⁻⁷ S cm-1 at 28° C., and continuously increase to 9.60×10⁻⁶ S cm-1 and 1.33× 10-5 S cm-1 at 88° C., respectively. Remarkably, FIG. 8 demonstrates that ANP-C-1.0k displayed higher ionic conductivity compared to ANP-PEG1k, which has the same linker length but exists in the form of a polymer powder due to the synthesis method. SEM images shown in FIG. 9 also reveal that ANP-C-1.0K exhibits a more consistent and smoother surface compared to ANP-PEG1k, leading to enhanced lithium-ion conduction. This highlights the advantage of directly producing anionic network electrolyte membranes. On the other side, ANP-C-2.0k, ANP-C-3.4k, and ANP-C-5.0k show lower ionic conductivities at 28° C., but there is a rapid increase in conductivity upon initial heating. This phenomenon can likely be attributed to the formation of crystalline regions within the network structure of PEO segments as the chain length of the PEO linker increases. As the temperature rises, these crystalline regions transition into an amorphous state, enabling faster movement of lithium ions and consequently leading to a sharp rise in conductivity during the initial heating period. Notably, ANP-C-2.0k demonstrates the highest ionic conductivity at 3.36×10⁻⁵ S cm⁻¹ when measured at 88° C.

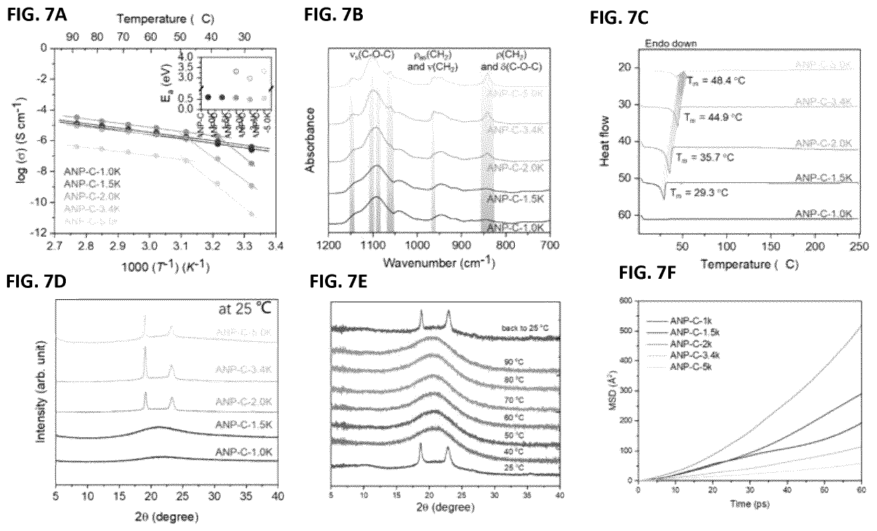

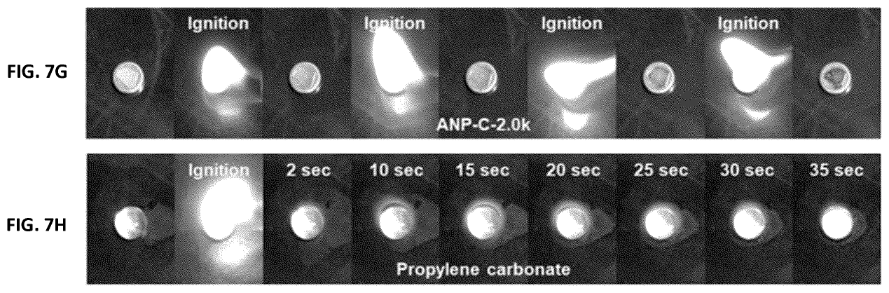

The temperature-dependent behavior of the ionic conductivities was investigated via Arrhenius and Nernst-Einstein equations (inset of FIG. 7A). ANP-C-2.0k, ANP-C-3.4k, and ANP-C-5.0k show a higher activation energy ranging from 2.97 eV to 3.33 eV in the presence of part crystallization regions. Conversely, all ANP-C-nKs display a lower activation energy ranging from 0.49 eV to 0.60 eV when they are entirely in an amorphous state, comparable to values observed in some liquid electrolytes.

FT-IR spectroscopy is utilized to examine the crystalline and amorphous phases at room temperature within an anionic network structure, as well as the dipole-dipole interactions involving Li-ion and PEO. Within the spectral range of 1000-1200 cm-1, the characteristic triplet of s (C—O—C) at 1145, 1107, and 1060 cm 1 signifies the presence of the crystalline phase in PEO, with a sharp and intense central peak. In FIG. 7B, it can be observed that the intensity of the (C—O—C) centered around 1107 cm-1 decreases, while the two sharp peaks at 1145 and 1060 cm-1 undergo a reduction in intensity, broadening, and eventually disappearing as the linker length within the network decreases. Consequently, ANP-C-1.0k and ANP-C-1.5K display an almost negligible crystalline phase, while ANP-C-5.0k demonstrates higher crystallinity. Furthermore, the FTIR spectrum also reveals a heightened ion-dipole interaction between Li+ ions and the C—O—C group of PEO when the linker length is reduced. This is evidenced by an upshift and intensification of the s (C—O—C) bond stretching frequency, as well as a downward shift and reduction in intensity of peaks at 960 and 945 cm⁻¹.

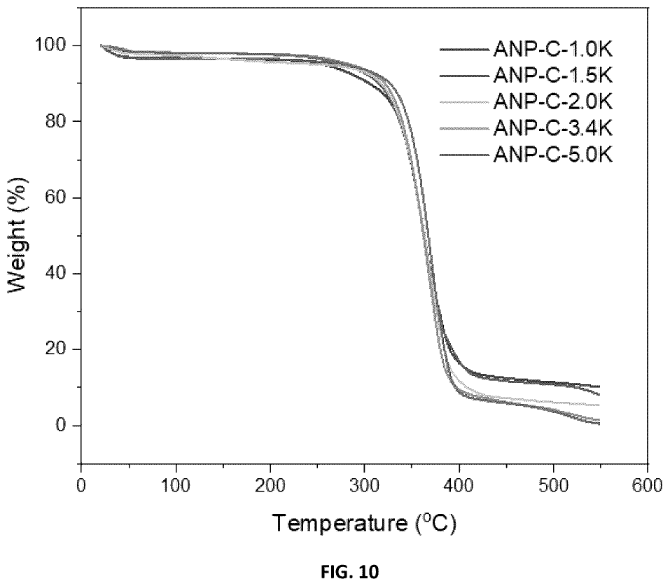

The phase transition behavior of all ANP-C-nKs was investigated using differential scanning calorimetry (DSC). FIG. 7C illustrates that ANP-C-1.0k and ANP-C-1.5k exhibit no discernible melting peak above 30° C., whereas the remaining ANP-C-nKs display a clear melting peak above 30° C. This suggests that the rapid increase region in the Arrhenius plot is attributable to the transition from the crystalline phase to the amorphous phase. The melting peak shifts to higher temperatures and increases in intensity, thereby confirming the influence of increasing linker length on enlarging the crystalline phase domain within the network. Furthermore, the temperature at which the melting peak occurs aligns with the transition temperature observed in the Arrhenius plot. In addition, the thermal stability of all ANP-C-nKs was also investigated using TGA tests. All ANP-C-nKs membranes exhibited outstanding thermal stability (up to 300° C.), which indicates promising application in high temperature conditions (FIG. 10).

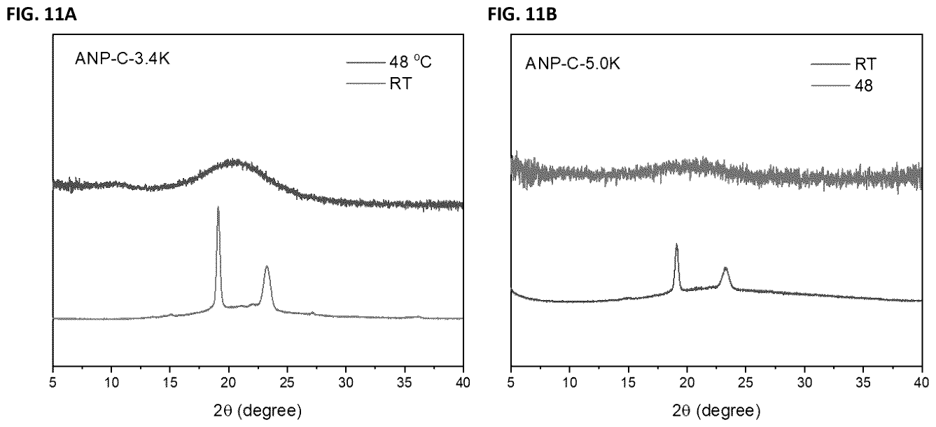

Based on the X-ray diffraction (XRD) pattern depicted in FIG. 7D, the broad diffraction peak observed at approximately 20° for ANP-C-1k and ANP-C-1.5k indicates their amorphous nature, while the presence of two distinct peaks at 19.15° and 23.30° suggests the crystal structure of ANP-C-2k, ANP-C-3.4k, and ANP-C-5k at room temperature. [27] However, upon increasing the temperature, these sharp peaks transformed into a broad diffraction peak, signifying the disappearance of the crystalline phase within ANP-C-2.0k, as shown in FIG. 7E. Besides, ANP-C-2.0K demonstrates a thermally stable amorphous structure above 40° C. Also, the two distinct peaks of ANP-C-3.4k and ANP-C-5k become broad diffraction peaks when the temperature is increased to 48° C. (FIGS. 11A and 11B).

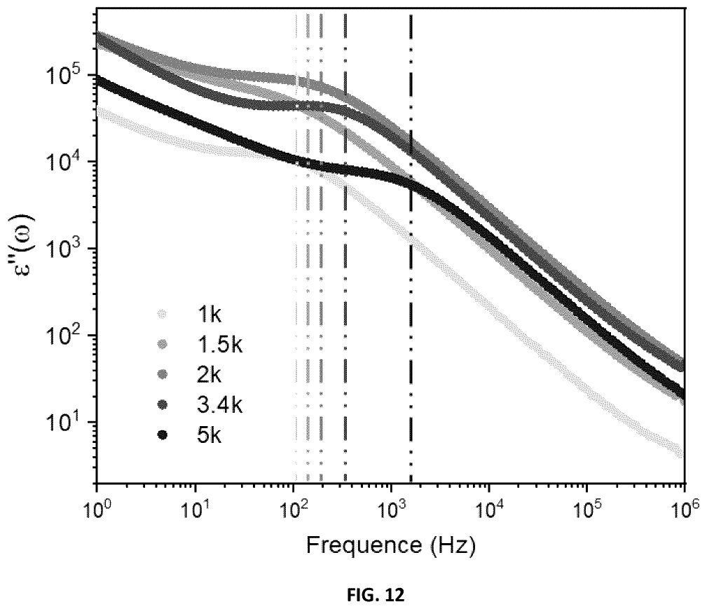

FIG. 7F displays MD simulation findings of the mean square-displacement (MSD) of the lithium cation in various ANP-C-nKs at 70° C. It indicates that ANP-C-2k exhibits the highest lithium-ion mobility compared to the others at 70° C. However, ANP-C-2k demonstrates slightly lower lithium-ion mobility than ANP-C-1.0k and ANP-C-1.5k at 25° C., which is attributed to partial crystallization in ANP-C-2.0k (FIG. 12). These simulation results align with the experimental findings.

In addition, combustion experiments were conducted to validate the fire-resistant properties of the solid-state electrolyte of the present invention. Notably, ANP-C-2.0k undergoes decomposition in the presence of an open flame without ignition, while propylene carbonate exhibits high flammability (FIG. 7G and FIG. 7H). The remarkable flame retardancy of ANP-C-2.0k can be attributed to fluorine substitution in the anionic nodes, as previous research has associated fluorination with reduced flammability in ether and carbonate-based electrolytes. [28-30] These results unequivocally demonstrate the exceptional non-flammability of ANP-C-2.0k and its efficacy in ensuring safety during battery applications.

To further investigate Li-ion transport behavior, additional molecular dynamic (MD) simulations were conducted on anionic networks. MD simulations were carried out using the program, Materials Studio. The Universal force field was used to simulate interatomic interactions because of its flexibility to a broad spectrum of systems such as organic molecules and metal complexes. The whole borate node and Li+ are set as one negative charge and one positive charge, respectively. The partial charges of the borate node and SH-PEG-SH are calculated by RESP method implanted in Multiwfn software. The wave function and the optimized structure for the RESP calculation are generated in wB97M-V/def2-TVZP level by the ORCA package. After setting the charges, the simulations are carried out using the isothermal-isobaric (with a constant number of atoms, constant pressure and constant temperature, NPT). Unless otherwise specified, a time step of lfs was used for all simulations. The Andersen thermostat was utilized for temperature control, while the Berendsen barostat was used for pressure control. Newton's equation was integrated using the Verlet algorithm. Van der Waals interactions were computed using atom-based summation with a cut-off distance of 9.5 Å, and electrostatic interactions were computed using the Ewald summation.

The initial simulation structures were built by Materials Visualizer which is embedded inside the software. Each simulation contained 8 Li+ atoms and 8 anionic networks. The systems were heated to 343K for at least 2 ns to simulate the experimental preparation temperature. After the structure shrinks to the experimental density, to achieve ion equilibrium, annealing procedures were employed. The tests were carried out from 298K to 600K 5 times with each interval of 50K lasting 50 ps. Simulations of the Li transport under applied voltage used potentials of strength between 4 and 8 V/nm along the z axis. Snapshots of the trajectory are recorded every lfs.

In order to study the effectiveness of the Li+ transportation, the mean square displacement (MSD) method was carried out to investigate the movements of atoms and molecular segments of the systems. The MSD can be obtained from the position change of particles in unit time in a molecular dynamics (MD) simulation by following equation:

$$MSD = \frac{1}{τ - Δ t} {\int }_{0}^{τ - Δ t} {[ r ( t - Δ t ) - r ( t ) ]}^{2} dt$$

where τ represents the total production time and r(t) is the position at time t.

The radial distribution function g(r) was calculated as:

$$g ( r ) = \frac{d {n}_{r}}{ρ 4 π {r}^{2} d r}$$

where nᵣ is the atom number in the spherical shell, ρ is the number density of the whole system and r is the distance.

The Binding energy between the Li+ atoms and the network systems was calculated as:

$$Einteraction = Etotal - ( ELi + Enetwork )$$

where the Etotal, ELi and Enetwork are the total systems energy, the Lit energy in the periodic structure and the network energy, respectively.

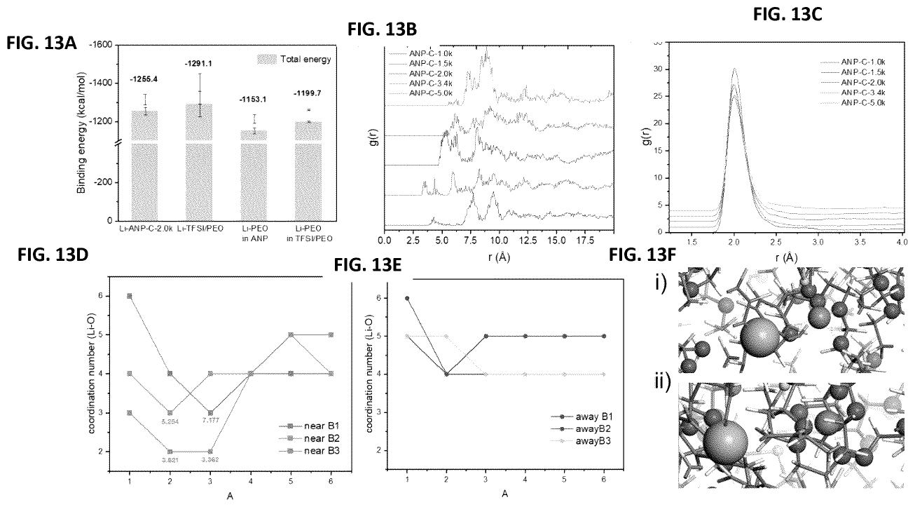

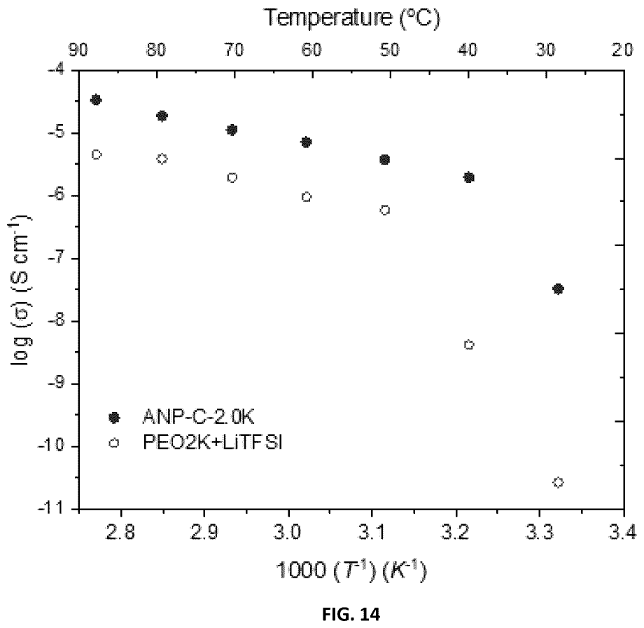

The LiTFSI/PEO2k network shared the same Li+ concentration as ANP-C-2.0k and possessed a comparable length of PEO. It is worth noting that the binding energy of lithium ion-ANP-C-2.0k is weaker than lithium-ion-TFSI-/PEO2k, indicating less attraction between Li ions and ANP-C-2.0k (FIG. 13A). This suggests that lithium ions are capable of faster movement within ANP-C-2.0k. These findings align with experimental results that demonstrate a higher ionic conductivity in ANP-C-2.0k compared to LiTFSI/PEO2k (FIG. 14). Furthermore, considering the influence of PEO alone, it was observed in FIG. 13A that PEO in ANP-C-2.0k exhibits weaker attraction towards Li ions compared to the PEO in the LiTFSI/PEO2k network. This implies that Li ions may possess higher mobility within the PEO chains of ANP-C-2.0k after the introduction of borate nodes.

Therefore, it is assumed that the borate nodes also play an important role in lithium-ion transport within the anionic network. The radial distribution function (RDF) analysis of Li-B exhibits varying Li-B distances for different anionic networks (FIG. 13B). At 25° C., ANP-C-1.5k, which demonstrates the highest ionic conductivity, exhibits the shortest Li-B distance, while ANP-C-5k, with the lowest ionic conductivity, shows the longest Li-B distance. Conversely, all anionic networks present similar Li-O distances (FIG. 13C). Based on these observations, it is proposed that lithium transport behavior may be influenced by the Li-B distance. To investigate further, the lithium-ion transport pathway was examined in the molecular model of ANP-C-2.0k. The RDF results indicate an average coordination of approximately 4.35 oxygen atoms from PEO chains to a Li-ion at 70° C. Additionally, through observation, it becomes evident that Li-ions move rapidly when passing by boron anions. Analysis of six selected Li-ions pathway in the ANP-C-2k model revealed that the coordinating numbers of Li-O decrease to their smallest values (2 or 3) when Li-ion approaches boron anions (FIG. 13C and FIG. 13E). On the other hand, the other three Li-ions, which do not approach boron anions, exhibit a consistent coordinating number above 4 and lack sudden rapid movement. Consequently, it is hypothesized that boron anions in ANP facilitate the dissociation of Li-ions from O atoms, thereby accelerating their transport within the electrolyte network. In this hypothetical conjecture, for ANP with longer linkers, lithium-ions are primarily transported through O atoms in PEO chains rather than directly hopping between B-anions. However, boron anions aid in propelling Li-ions, expediting their movement along PEO chains due to the dissociation effect (FIG. 13F).

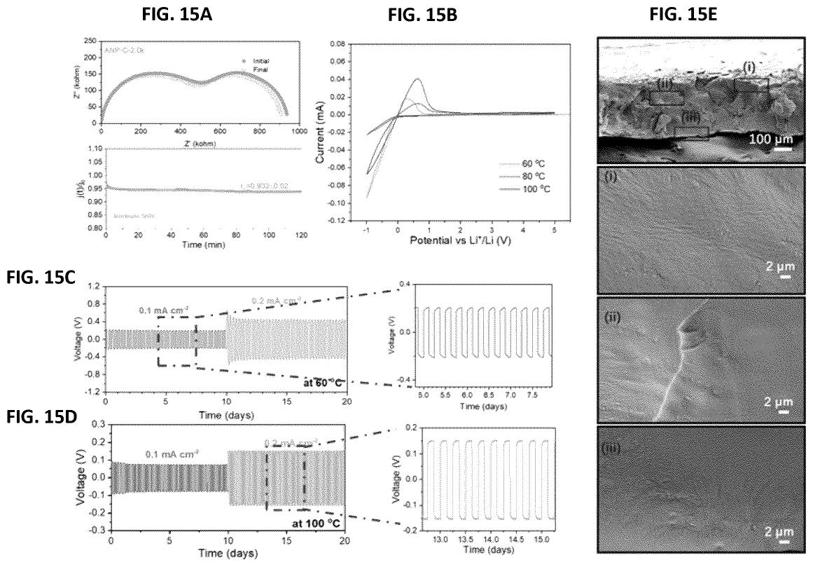

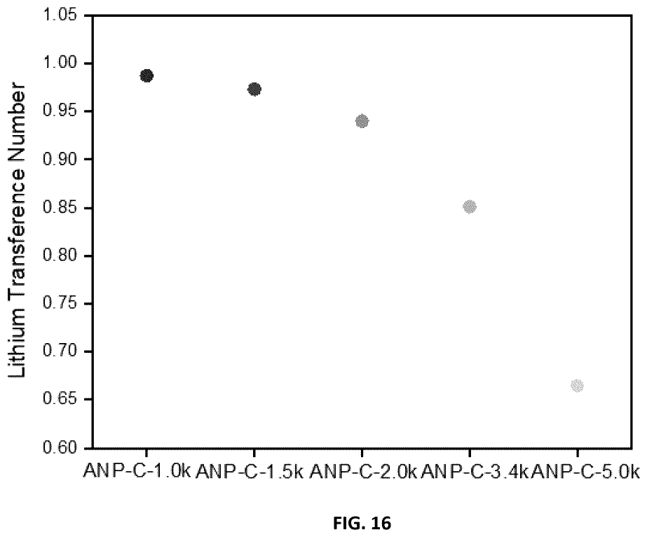

The electrochemical characterizations of the electrolyte membrane were studied. For this purpose, all electrolyte membranes were totally dried at 120° C. under vacuum at least 24 h before being transferred to a glove box filled with Ar. Before electrochemical or battery measurements, all membranes were stored at least 24 h in the glove box. Impedance spectroscopy was employed to analyze Li-ion selectivity in conduction at room temperature in a symmetric Li|ANP-C-2.0k|Li cell. Notably, the lithium transference number (tLi+=0.932, FIG. 15A, bottom) reveals that lithium cations are the exclusive mobile species, with a ratio of current carried by lithium cation to total current approaching one. Besides, ANP-C-1.0k and ANP-C-1.5k exhibit nearly unity lithium transference numbers (tLi+=0.987 and 0.973, respectively, FIG. 16), suggesting that anionic nodes are effectively anchored within the polymer network, resulting in high selectivity for Li cation conduction. However, an increase in linker length leads to a decrease in lithium transference number due to steric hindrance preventing full reaction between the double bond group and thiol group. Subsequent measurements detailed below were conducted utilizing ANP-C-2.0k as the prominent polymer due to its exceptional ionic conductivity and selectivity.

The ability to immobilize anions is shown by the lithium transference number (LTN), which is an important factor in single-ion polymer electrolytes. It is ideal for the lithium transference number to be close to one, and this can be achieved through structural and electrochemical methods. Determination of LTN in polymer electrolytes is done using the steady-state current method. An Ar-filled glove box is used to build symmetric Li|electrolyte|Li Swagelok cells. After allowing the Swagelok cell to reach equilibrium overnight, the impedance spectrum is recorded at 100 mV ac. Subsequently, a DC voltage of 100 mV is applied, and the current response is measured for 2 h. Following the DC polarization, the resistances of the electrolyte and the interface are measured using AC impedance. The LTN value is obtained using the given equation.

$${t}_{+} = \frac{{I}^{s} {R}_{b}^{s} ( Δ V - {I}^{0} {R}_{ct}^{0} )}{{I}^{0} {R}_{b}^{0} ( Δ V - {I}^{s} {R}_{ct}^{s} )}$$

in which ΔV means the DC voltage; R_{b}⁰ and R_{b}^{s} are the bulk resistance before and after applying the voltage; I⁰ and I^{s} indicate the initial current and steady-state current; R₀^{ct} is the charge transfer resistance before the voltage step while Ret is the resistance after polarization.

The oxidative stability of ANP-C-2.0k was assessed using cyclic voltammetry on stainless steel electrodes within the temperature range of 60, 80, and 100° C. The measurements were conducted at voltages ranging from −1.0 to 5.2 V (vs Li/Li+) with a scan rate of 0.3 mV s⁻¹ (FIG. 15B). Notably, the ANP-C-2.0k electrolyte exhibited a low oxidative current and exceptional stability up to 5.0 V versus Li/Lit, even at elevated temperatures. This enhanced stability is likely due to the presence of stationary tetraphenylborate anions in ANP-C-2.0k. [18] Furthermore, the observed stability surpasses the values achieved by previous anionic network polymers (4.2 V or 4.5 V vs Li/Li+). [18, 19] This superior stability can be attributed to the smoother surface and reduced defects of ANP-C-2.0k resulting from the novel membrane synthesis method. The satisfactory electrochemical stability at high temperatures and up to 5.0 V versus Li/Li+ indicates the compatibility of ANP-C-2.0k for potential utilization in Li-metal batteries operating in extreme thermal conditions.

To determine the electrochemical working window of polymer electrolytes in connection with cyclic voltammetry, a three-electrode Swagelok cell is utilized. Stainless steel served as the working electrode, while the counter electrode and reference electrode consist of lithium chips. The investigation of the electrochemical stability window involved performing voltage sweeps from −0.5 V to 5.2 V at a rate of 0.3 mV/s.

To further investigate the electrochemical stability, galvanostatic lithium plating/stripping electrochemical cycling measurements were conducted in symmetric Li|membrane|Li cells. The cycling measurements were carried out in a Swagelok cell by charging/discharging at temperatures of 60° C. and 100° C., utilizing current densities ranging from 0.1 to 0.2 mA cm 2. A practical cycling process was emulated by implementing a 3-hour lithium plating followed by a 3-hour lithium stripping (FIG. 15C and FIG. 15D). The symmetric cells demonstrated a notably stable voltage polarization throughout a 20-day period while successfully plating and stripping lithium electrodes. Furthermore, ANP-C-2.0k exhibited lower overpotential and reduced fluctuations when measured at 100° C. compared to 60° C., indicating its high electrochemical stability on the Li-metal surface under elevated temperatures. Scanning Electron Microscopy (SEM) was employed to visualize the resistance to dendrite growth in the membrane following galvanostatic cycling measurements. SEM images (FIG. 15E) revealed the absence of noticeable damage in the electrolyte membrane, further indicating the successful suppression of lithium dendrite growth.

To assess the applicability of ANP-C-2.0k in lithium metal batteries, solvent-free solid-state batteries incorporating LiFePO4 (LFP) were constructed. For a Li|LFP full cell performance test, the LFP cathode electrode was prepared by mixing LiFePO₄ (active material, 60 wt %), electrolyte (20 wt %), conductive carbon black (10 wt %), and poly(vinylidene fluoride) (10 wt %) in NMP. The homogeneous cathode slurry was then cast on an Al foil. Then, the electrode was dried under a vacuum at 80° C. for 12 h. The typical mass loading of the active materials was around 1.0 mg cm 2. The rate capability and cycle life of Li|SPE|LFP full cells were measured on a Squidstat electrochemical workstation in the voltage range of 2.5-3.8 V at different temperatures. The C rates in all of the electrochemical measurements were defined on the basis of 1 C═170 mA g⁻¹.

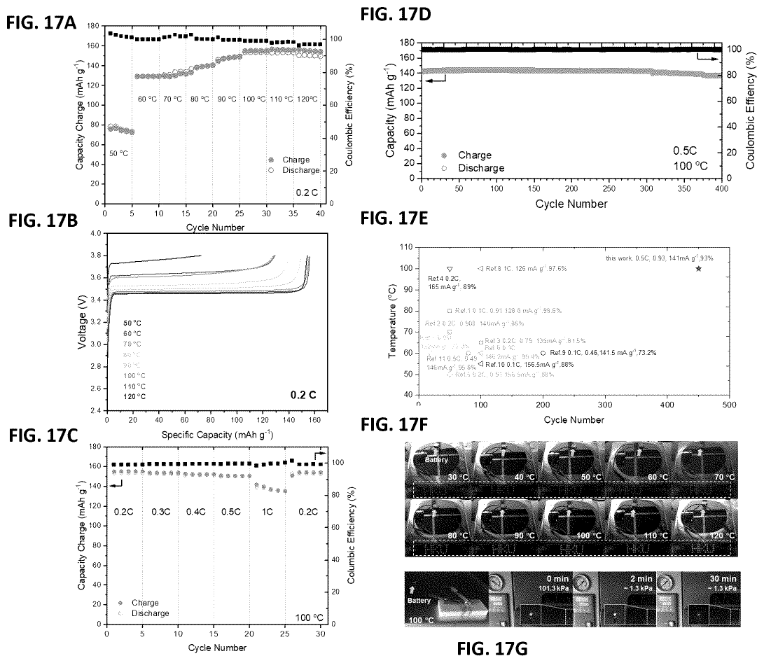

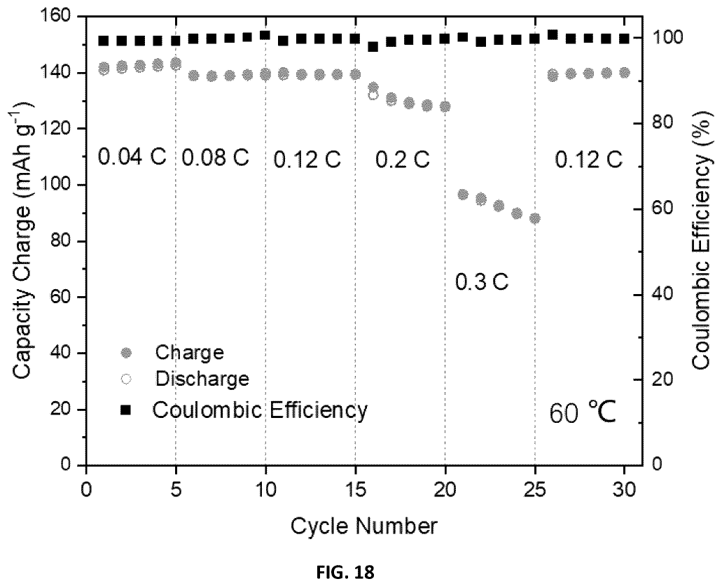

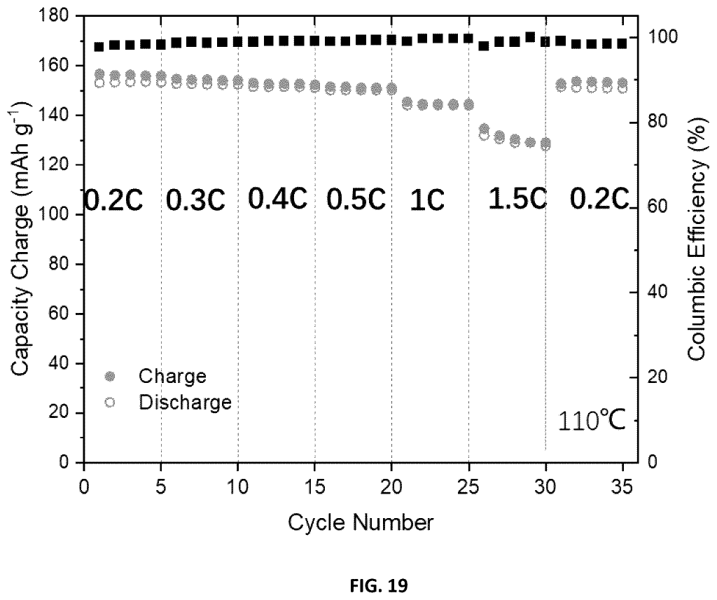

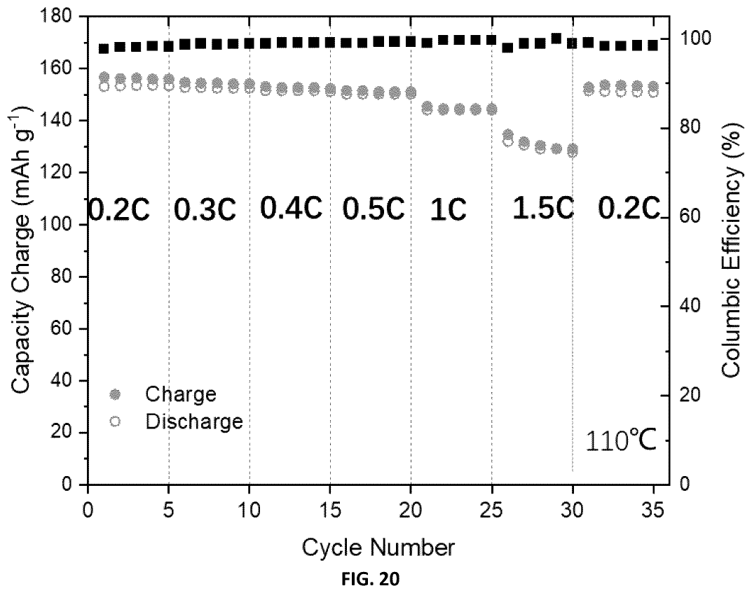

Charge-discharge capacities of LFP/ANP-C-2.0k/Li coin cells were evaluated at various temperatures (FIG. 17A). The coin cells exhibited excellent capacity reversibility within the temperature range of 30 to 100° C. at a rate of 0.2° C. while a slight decrease in capacity was observed during discharge at 110° C. and 120° C. Notably, the LFP/ANP-C-2.0k/Li cells demonstrated increased capacities with rising temperature, i.e., yielding 129, 153.5, and 156.4 mA h g−1 at 60° C., 100° C., and 110° C., respectively. The battery charge curves obtained at varying temperatures (0.2° C. rate) are presented in FIG. 17B. Notably, as the temperature rises, a more distinct and well-defined potential plateau is observed. This observation strongly suggests the maintenance of stable energy delivery, even when operating at elevated temperatures. The rate performances of the LFP/ANP-C-2.0k/Li cell were investigated at different temperatures. The specific capacity of the battery at 100° C., measured at rates of 0.2° C., 0.3° C., 0.4° C., 0.5° C., and 1.0° C., were determined to be 155.2, 153.9, 152.5, 150.8, and 138.1 mAh g⁻¹, respectively (FIG. 17C). Remarkably, the capacity was recovered after cycling at 1.0° C., indicating exceptional rate capability. Furthermore, the rate performances of the LFP/ANP-C-2.0k/Li cell at 60° C., 90° C., and 110° C. are depicted in FIGS. 18-20, demonstrating reversible charge-discharge capacity after cycling at different rates under varying high temperatures.

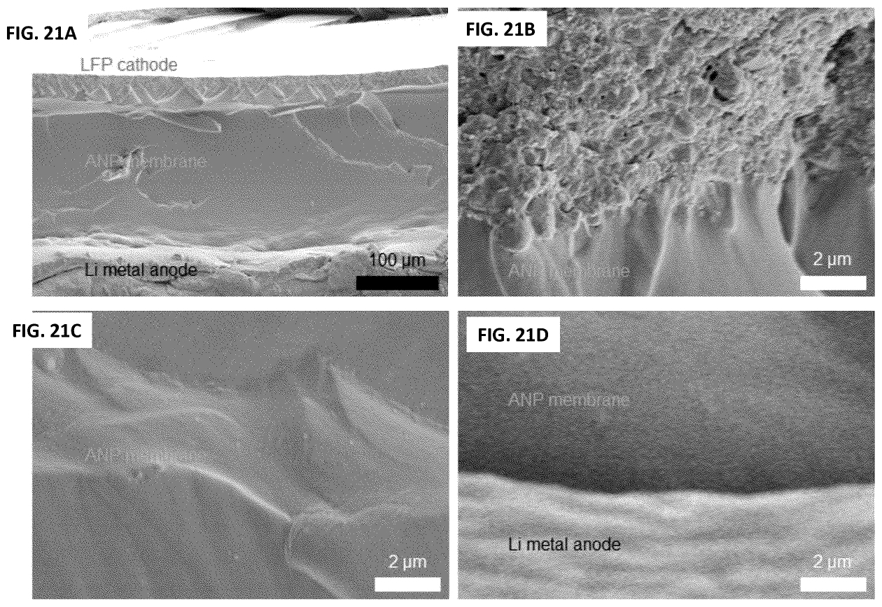

After conducting cycling tests at various rates, the interphase between the LFP cathode and electrolyte was investigated. SEM images in FIGS. 21A to 21C demonstrate a strong adherence of the LFP cathode to the electrolyte membrane, indicating favorable compatibility and a good interphase for ion conduction.

The long-term cycling performance of the LFP/ANP-C-2.0k/Li cell was assessed at 100° C. and a rate of 0.5° C. FIG. 17D illustrates that the cell exhibited an average coulombic efficiency (CE) of close to 100% during cycling. The initial charge specific capacity reached 142 mA h g⁻¹, and after 400 cycles, but showed a slight decrease to 136.5 mAh g⁻¹, with a retention rate of 96.1%. These results highlight the excellent long-term stability of the LFP/ANP-C-2.0k/Li cell even under high-temperature conditions. Besides, the ANP-C-2.0k exhibited superior performance in capacity, rate, operating temperature, and lifetime when compared to other state-of-the-art electrolytes in Li metal batteries (FIG. 17E). [31-41]

To assess the operability of the LFP/ANP-C-2.0k/Li cell across a wide temperature range, an experimental setup was devised (see FIG. 17F). The LED exhibited continuous illumination as the temperature ranged from 30 to 120° C. Notably, the brightness of the LED increased proportionally with temperature, indicating a high discharge current density resulting from reduced internal resistance. Subsequently, the coin cell underwent testing in a vacuum oven at 100° C. to emulate harsh operating conditions. As depicted in FIG. 17G, the coin cell demonstrated functionality for over 30 minutes under conditions of 100° C. and 1.3 kPa, thus affirming its potential for operation in high-temperature and high-altitude environments.

Thus, the present invention provides a novel and efficient approach for the direct fabrication of a solvent-free single-ion perfluorinated-tetraphenylborate-anions polymer electrolyte membrane via click reaction. The resulting flexible membrane exhibits remarkable cyclability performance at high temperatures (over 400 cycles at 100° C. and at 0.5° C.), high lithium selectivity (0.93), and a wide working window (5.0 V). Additionally, the membrane shows superior non-flammability properties and can operate effectively under various temperature ranges and negative pressure conditions, making it potentially practical for use in high-temperature and harsh environments. Moreover, by employing molecular dynamic simulations, valuable insights have been provided into the transport of lithium-ions in ANP. It has been revealed that Li-ions are primarily transported through O atoms in PEO chains rather than directly hopping between B-anions. However, boron anions aid in propelling Li-ions, expediting their movement along PEO chains due to the dissociation effect. These new findings also pave the way for future advancements in the design of anionic electrolytes for next-generation lithium batteries.

The above are only specific implementations of the invention and are not intended to limit the scope of protection of the invention. Any modifications or substitutes apparent to those skilled in the art shall fall within the scope of protection of the invention. Therefore, the protected scope of the invention shall be subject to the scope of protection of the claims.

### REFERENCES

The cited references in this application are incorporated herein by reference in their entirety and are as follows:
[11. J. M. Tarascon and M. Armand, Nature, 2001, 414, 359-367.
[2] L. Cheng, J. Yan, G.-N. Zhu, J.-Y. Luo, C.-X. Wang and Y.-Y. Xia, J. Mater. Chem., 2010, 20, 595-602.
[3] L. Long, S. Wang, M. Xiao and Y. Meng, J. Mater. Chem. A, 2016, 4, 10038-10069.
[4] Y. Feng, L. M. Zhou, H. Ma, Z. H. Wu, Q. Zhao, H. X. Li, K. Zhang and J. Chen, Energy Environ. Sci., 2022, 15, 1711-+.
[5] V. Kumaravel, J. Bartlett and S. C. Pillai, Adv. Energy Mater., 2021, 11, 2002869.
[6] D. Lin, Y. Liu and Y. Cui, Nature Nanotechnology, 2017, 12, 194-206.
[7] E. M. Erickson, E. Markevich, G. Salitra, D. Sharon, D. Hirshberg, E. de la Llave, I. Shterenberg, A. Rosenman, A. Frimer and D. Aurbach, J. Electrochem. Soc., 2015, 162, A2424.
[8] R. Bouchet, S. Maria, R. Meziane, A. Aboulaich, L. Lienafa, J.-P. Bonnet, T. N. T. Phan, D. Bertin, D. Gigmes, D. Devaux, R. Denoyel and M. Armand, Nat. Mater., 2013, 12, 452-457.
[9] D. J. Bannister, G. R. Davies, I. M. Ward and J. E. McIntyre, Polymer, 1984, 25, 1291-1296.
[10] M. Doyle, T. F. Fuller and J. Newman, Electrochim. Acta, 1994, 39, 2073-2081.
[11] G. J. Martyna, D. J. Tobias and M. L. Klein, J. Chem. Phys., 1994, 101, 4177-4189.
[12] M. Doyle and J. Newman, Electrochim. Acta, 1995, 40, 2191-2196.
[13] Y. Chen, Y. Tian, Z. Li, N. Zhang, D. Zeng, G. Xu, Y. Zhang, Y. Sun, H. Ke and H. Cheng, J. Membr. Sci., 2018, 566, 181-189.
[14] Z. Xue, D. He and X. Xie, J. Mater. Chem. A, 2015, 3, 19218-19253.
[15] X. Cheng, J. Pan, Y. Zhao, M. Liao and H. Peng, Adv. Energy Mater., 2018, 8, 1702184.
[16] S. Liang, U. H. Choi, W. Liu, J. Runt and R. H. Colby, Chem. Mater., 2012, 24, 2316-2323.
[17] J. F. Van Humbeck, M. L. Aubrey, A. Alsbaiee, R. Ameloot, G. W. Coates, W. R. Dichtel and J. R. Long, Chem. Sci., 2015, 6, 5499-5505.
[18] D.-M. Shin, J. E. Bachman, M. K. Taylor, J. Kamcev, J. G. Park, M. E. Ziebel, E. Velasquez, N. N. Jarenwattananon, G. K. Sethi, Y. Cui and J. R. Long, Adv. Mater., 2020, 32, 1905771.
[19] J. Gao, J. Zhou, C. Wang, X. Ma, K. Jiang, E. Kim, C. Li, H. Liu, L. Xu, H. C. Shum, S.-P. Feng and D.-M. Shin, Chem. Eng. J., 2022, 450, 138407.
[20] M. L. Aubrey, J. C. Axelson, K. E. Engler and J. R. Long, Macromolecules, 2021, 54, 7582-7589.
[21] H. Li, J. Dai, Q. Xu, C. Lu, G. Yang, F. Wang, J. Nie, X. Hu, N. Dong and J. Shi, European Polymer Journal, 2019, 116, 74-83.
[22] H. Wang, Q. Wang, X. Cao, Y. He, K. Wu, J. Yang, H. Zhou, W. Liu and X. Sun, Adv. Mater., 2020, 32, 2001259.
[23] M. Gauthier, T. J. Carney, A. Grimaud, L. Giordano, N. Pour, H.-H. Chang, D. P. Fenning, S. F. Lux, O. Paschos, C. Bauer, F. Maglia, S. Lupart, P. Lamp and Y. Shao-Horn, J. Phys. Chem. Lett., 2015, 6, 4653-4672.
[24] I. Villaluenga, K. H. Wujcik, W. Tong, D. Devaux, D. H. C. Wong, J. M. DeSimone and N. P. Balsara, Proceedings of the National Academy of Sciences of the United States of America, 2016, 113, 52-57.
[25] L. H. Sim, S. N. Gan, C. H. Chan and R. Yahya, Spectrochimica Acta Part A: Molecular and Biomolecular Spectroscopy, 2010, 76, 287-292.
[26] F. E. B. Jr. and J. V. Koleske, Poly (Ethylene Oxide), Academic Press, Inc., New York, 1976.
[27] M. Basappa, H. Ganesha, S. Veeresh, Y. S. Nagaraju, M. Vandana, H. Vijeth and H. Devendrappa, Chemical Physics Letters, 2022, 799, 139609.
[28] X. Fan, L. Chen, O. Borodin, X. Ji, J. Chen, S. Hou, T. Deng, J. Zheng, C. Yang, S.-C. Liou, K. Amine, K. Xu and C. Wang, Nature Nanotechnology, 2018, 13, 715-722.
[29] K. Xu, S. Zhang, J. L. Allen and T. R. Jow, J. Electrochem. Soc., 2002, 149, A1079.
[30] G. Nagasubramanian and C. J. Orendorff, J. Power Sources, 2011, 196, 8604-8609.
[31] F. Lu, G. Li, Y. Yu, X. Gao, L. Zheng and Z. Chen, Chem. Eng. J., 2020, 384, 123237.
[32] Q. Shi, L. Xue, D. Qin, B. Du, J. Wang and L. Chen, J. Mater. Chem. A, 2014, 2, 15952-15957.
[33] P.-F. Cao, B. Li, G. Yang, S. Zhao, J. Townsend, K. Xing, Z. Qiang, K. D. Vogiatzis, A. P. Sokolov, J. Nanda and T. Saito, Macromolecules, 2020, 53, 3591-3601.
[34] T. Chen, Z. Jin, Y. Liu, X. Zhang, H. Wu, M. Li, W. Feng, Q. Zhang and C. Wang, Angew. Chem., Int. Ed., 2022, 61, e202207645.
[35] G. Luo, B. Yuan, T. Guan, F. Cheng, W. Zhang and J. Chen, ACS Appl. Energy Mater., 2019, 2, 3028-3034.
[36] X. F. Yan, Z. B. Li, Z. Y. Wen and W. Q. Han, J Phys Chem C, 2017, 121, 1431-1435.
[37] J. F. Wu, W. K. Pang, V. K. Peterson, L. Wei and X. Guo, Acs Appl Mater Inter, 2017, 9, 12461-12468.
[38] F. M. Du, N. Zhao, Y. Q. Li, C. Chen, Z. W. Liu and X. X. Guo, J. Power Sources, 2015, 300, 24-28.
39. J. X. Zhang, N. Zhao, M. Zhang, Y. Q. Li, P. K. Chu, X. X. Guo, Z. F. Di, X. Wang and H. Li, Nano Energy, 2016, 28, 447-454.
[40] W. Y. Lei, X. X. Jiao, S. G. Yang, F. B. Ajdari, M. Salavati-Niasari, Y. Y. Feng, J. Q. Yin, G. Ungar and J. X. Song, Energy Storage Mater, 2022, 49, 502-508.
[41] F. R. Sun, Y. B. Yang, S. Zhao, Y. T. Wang, M. X. Tang, Q. Z. Huang, Y. Ren, H. Su, B. Y. Wang, N. Zhao, X. X. Guo and H. J. Yu, Acs Energy Lett, 2022, 7, 2835-2844.

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A method of fabricating a crack-free anionic network polymer (ANP) electrolyte membrane, comprising the steps of:
conjugating anionic nodes (Monomer-Cl) with a short alkene possessing a C═C (carbon double bond) terminal group to form a structure with alkene moieties;
mixing the modified anionic nodes with an ionic conductive polymer linker in organic solvent; and
exposing the mixture to ultraviolet (UV) light to triggers a polymerization process via click reaction to form a crack-free anionic network polymer carbon double bond (ANP-C) membrane.

2. The method of fabricating an ANP membrane according to claim 1 wherein the anionic nodes are lithium tetrakis 4-(chloromethyl)-2.3.5.6-tetrafluorophenyl) borate and the short alkene is 5-hexenol, and
wherein the conjugation is by means of nucleophilic substitution.

3. The method of fabricating an ANP membrane according to claim 1 wherein the ionic conductive polymer liner is poly(ethylene glycol) (PEG) dithiol.

4. The method of fabricating an ANP membrane according to claim 2 wherein the lithium tetrakis 4-(chloromethyl)-2.3.5.6-tetrafluorophenyl) borate is formed by the steps of:
adding Tetrafluorobenzyl chloride into an oven-dried flask by syringe;
charging the flask with anhydrous diethyl ether via cannula and placing the flask into a dry ice bath;
slowing adding n-butyllithium in hexanes into the solution via syringe;
after one hour, adding boron trichloride in heptanes dropwise via syringe;
stirring the solution at less than −70° C. for 2 hours;
warming up the solution to room temperature as the dry ice evaporates;
after 18 hours using aqueous LiCl to quench the reaction;
collecting the resulting organic layer;
washing the layer with LiCl aqueous solution twice;
drying the layer with MgSO₄ to form a pale-yellow oil that is harvested by concentrating the organic solution via rotary evaporator;
transferring the yellow oil into a vial and dissolving dichloromethane in it;
purifying the resulting oil by precipitation in hexane three times; and
removing trace solvent under vacuum to obtain a white-yellow solid.

5. The method of fabricating an ANP membrane according to claim 4 wherein the Tetrafluorobenzyl chloride is formed by the steps of:
separately adding 2,3,5,6-tetrafluorobenzyl alcohol (10.0 g), tetrabutylammonium chloride and thionyl chloride into an oven-dried flask;
mixing the solution at 85° C. for 2 hours,
after being cooled down to room temperature, placing the flask into a 0° C. ice bath;
slowly adding concentrated aqueous Na₂CO₃ to the solution;
adding solid Na₂CO₃ to adjust the solution to a pH of 6;
extracting the solution with diethyl ether four times;
collecting the organic layer and washing it with brine;
drying the layer with MgSO₄;
removing the diethyl ether by rotary evaporation under reduced pressure to obtain a yellow oil; and
using vacuum distillation to harvest a transparent oil into a flask surrounded by liquid N₂.

6. A method of fabricating an ANP-C-nK membrane, wherein nK represents the molecular weight of the linker, comprises the steps of:
dissolving a borate node with C═C monomer and SH-PEG-SH linker with the molecular ratio of 1:2 in DMSO, wherein the weight percentage of the mixture solution is around 50%;
adding DMPA (1% wt) into the mixture;
transferring the solution into a vacuum vessel to totally remove bubbles inside;
adding the mixture solution to a PDMS mold under UV light for 30 min until a membrane is formed;
soaking the membrane in methanol and THE respectively at 60° C. for 6 h three times to remove impurities;
drying the electrolyte membrane at 60° C. for removal of most of the solvent; and
further drying the electrolyte membrane at 120° C. under vacuum for 18 h to fully remove trace of solvent.

7. A battery comprising:
a LiFePO4 (LFP) layer,
an ANP-C-kN membrane layer made according to claim 4, and
a lithium (Li) layer.

8. The battery of claim 7 in the form of a coin cell and nK is 2.0k.

9. The battery of claim 7 wherein prior to assembly the membrane is dried at 120° C. under vacuum at least 24 hours.

10. The battery of claim 7 which is assembled in an argon filled glove box.

11. The battery of claim 7 wherein the LFP cathode electrode is prepared by:
mixing LiFePO₄ (active material, 60 wt %), electrolyte (20 wt %), conductive carbon black (10 wt %), and poly(vinylidene fluoride) (10 wt %) in NMP to form a homogeneous cathode slurry;
casting the homogeneous cathode slurry on an Al foil; and
drying the electrode under a vacuum at 80° C. for 12 h.
